(19) United States
(12) Patent Application Publication
(10) Pub. No.: US 2019/0376359 A1
(43) Pub. Date: Dec. 12, 2019

(54) HYDROPHOBIC DIELECTRIC SEALING MATERIALS

(71) Applicant: PA&E, Hermetic Solutions Group, LLC, Wenatchee, WA (US)

(72) Inventors: Hua Xia, Huffman, TX (US); Nelson Settles, East Wenatchee, WA (US); Gaery Rutherford, Wenatchee, WA (US)

(73) Assignee: PA&E, Hermetic Solutions Group, LLC, Wenatchee, WA (US)

(21) Appl. No.: 16/004,391

(22) Filed: Jun. 10, 2018

(51) Int. Cl. E21B 33/038; E21B 47/12; C09K 8/42

(52) U.S. Cl. CPC E21B 33/0385; G01V 3/34; C09K 8/422; E21B 47/122

(57) ABSTRACT

A hydrophobic dielectric sealing material is provided that is especially suitable for use in extreme environments such as for enabling downhole electrical feedthrough integrated logging tools reliable operation, especially, in a water or water-mud filled wellbore as first scenario or in moisture-rich oil-mud filled wellbores. In some embodiments, a hydrophobic dielectric sealing material may include: H₃BO₃ 10-60 mol %; Bi₂O₃ 10-50 mol %; MO 10-50 mol %; SiO₂ 0-15 mol %; and optionally one or more rare earth oxides 0-5 mol %. A method for making hydrophobic sealing material includes selecting water insoluble raw materials, form tetragonal phase dominated phase, and enlarge band-gap with wide-band-gap material. The morphology of the sealing material is preferably a tetrahedral phase dominated covalent bond network for obtaining high electrical insulation resistance, dielectric strength and hydrophobicity, and high mechanical strength in against downhole 30,000 PSI/300° C. water-based hostile environments.

### FIELD OF THE INVENTION

This patent specification relates to the field of dielectric sealing materials. More specifically, this patent specification relates to hydrophobic dielectric sealing materials having sustained electrical resistance in high pressure and high temperature water-based or moisture-rich environments.

### BACKGROUND

Exploration, drilling, completion and production of the hydrocarbons in a wellbore require downhole logging tools for measuring resistivity, density, gases, fluids, and lithology etc. A logging system is lowered into a wellbore to determine if economics exists for well completion and production. Downhole logging tool and electrical circuits are packaged in a hermetically sealed sonde enclosure or package to protect the circuits from downhole corrosive environments and humidity. The sonde enclosure uses an electrical feedthrough that transmits the power to inside electronics or sends the measured downhole data to surface instruments.

In addition to the sonde portion, a logging tool may also include at least an electrical feedthrough for transmitting electric power and data signals from sonde to up-hole surface instrument. For permanent installations in the downhole environment, it is important that these electrical feedthroughs are reliable. In particular, it is important that the downhole fluid is prevented from penetrating the electrical feedthroughs because the presence of the conductive fluid, such as seawater, in the electrical feedthroughs can cause a short circuit in the system. An electrical feedthrough may carry substantial amounts of power with signals of a few thousand volts that require the dielectric sealing material to be of not only high insulation resistance but also of moisture-resistance or/and even hydrophobicity.

An electrical feedthrough generally comprises an electrically-conductive pin(s), an outer metal enclosure, and an electrically insulating material, hermetically sealed to the center conductive pin(s) and the outer metal enclosure. A dielectric sealing material is often used to insulate the conductive pins from the feedthrough package. The electrical feedthrough may be sealed in a dielectric sealing material, either a thermoplastic polymer or a glass-ceramic material.

The high-dielectric-strength sealing material is a critical element for making a downhole electrical feedthrough reliable operation in water-based or moisture-rich oil-based wellbores. In fact, a sealing material may be of high mechanical strength that enables an electrical feedthrough package to survive downhole harsh condition, but it can only be used in oil-based wellbores. The downhole logging tool failures often occur due to the loss of electrical insulation from moisture-rich oil wellbore or water-based wellbore. It is desirable for a sealing material to have not only high mechanical strengths but also have high moisture-resistance or hydrophobicity to mitigate any potential failure modes from a downhole electrical feedthrough.

Thermoplastic polymeric materials, such as aromatic polyether ketones (PEEK, PEK, PAEK, and PEKK), are commonly used sealing material with good moisture-resistance for sealing downhole electrical feedthrough. But the structural integrity has to be compromised at higher downhole temperatures because of mechanical creep degradation that causes the pin surface to delaminate from the thermoplastic sealing material. This may lead to catastrophic electrical breakdown if moisture or water passes into the sonde enclosure or directly causes electrical failure by the loss of the insulation from the dielectric thermoplastic polymeric material. Glass, ceramic, and glass-ceramic (such as Corning 7070, Schott 8061, Li₂O—Al₂O₃—SiO₂, and —Al₂O₃—SiO₂ etc.) are also commonly used as dielectric sealing materials that could provide high electric resistivity, high mechanical strength, toughness, and high break-down voltage for making high performance electrical feedthrough. Most of these sealing materials are highly resistant to extreme temperature, however, they tend to be hydrophilic (water-attracting) rather than hydrophobic (water-repelling). Although a polymer modifier, such as PTFE or silicone-based substances, can be used to render the hydrophilic surface to have a water shedding surface, these deteriorate when heated or can easily be destroyed by wearing or by high pressure. The sealing material surface of containing —OH hydroxyl ions may cause potential catastrophic electrical breakdown, especially, when the volumetric resistance becomes less than 5,000 Mg at the 30,000 PSI pressure and 177° C. harsh conditions.

Rare earth oxide based hydrophobic ceramic materials have been disclosed by Gisele Azimi et al. [Natural Material, vol. 12, 315 (2013)], that demonstrate a class of ceramics comprising the entire lanthanide oxide series, ranging from ceria to lutecia, to be intrinsically hydrophobic. The hydrophobicity of these rare earth oxides is attributed to the unique electronic structure and minimized polar interactions at these surfaces from water molecules. The investigated ceramic materials promote dropwise condensation, repel impinging water droplets, and sustain hydrophobicity even after exposure to steam. However, leveraging such fundamental science progress to a downhole electrical feedthrough sealing material seems very challenging because the unique electronic structure may be modified by downhole conductive fluids (contaminated water, brine, CO₂ or H₂S, containing metal ions etc.). It is also another challenge with a coating method to integrate a rare earth oxide onto conventional sealing material surface for electrical feedthrough hermetic seal with acceptable cost-effectiveness and reliability.

It is clear that an electrical feedthrough will be subjected to a variety of harsh environments such as 177° C. downhole temperature and up to 30,000 PSI hydraulic pressure. There is a need for a high-strength hydrophobic dielectric sealing material for forming the electrical feedthrough seal that not only provides high mechanical strength against hermetic failure but also provides hydrophobicity to enhance electrical insulation strength against moisture or water absorption induced electric insulation failure. There is a further need for a high mechanical and dielectric strength dielectric sealing material in general, and for a hydrophobic high-strength dielectric sealing material in particular for enabling downhole electrical feedthrough reliable operation, especially, in a water or water-mud filled wellbore or moisture-rich oil or oil-mud filled wellbore.

### BRIEF SUMMARY OF THE INVENTION

A hydrophobic dielectric sealing material is provided having high mechanical and dielectric strength. The dielectric sealing material is especially suitable for use in extreme environments such as for enabling downhole electrical feedthrough integrated logging tools reliable operation, especially, in a water or water-mud filled wellbore as the first scenario or in moisture-rich oil or oil-mud filled wellbores.

In some embodiments, a hydrophobic dielectric sealing material can be made from x.H₃BO₃-y.Bi₂O₃-(1−x−y−z−δ).MO-z.SiO₂-δ.REO multi-composition material platform with MO=TiO₂, BaO, ZnO, Fe₂O₃ etc., and REO represents rare earth oxide oxides. The dielectric properties of this multi-composition material platform may be engineered for having hydrophobic performance by synthesizing binary-, ternary-, quaternary-, and quinary-compositional systems. The used chemical compositions are critical for synthesizing hydrophobic dielectric sealing material that requires no alkali ions and oxides (such as, Li+, Na+, K+, and P+, CaO, CaCO₃, Li₂O, Li₂O₂, LiO₂, Na₂O, Na₂O₂, NaO₂, K₂O, K₂O₂, and KO₂, etc.) and metal ions (Fe⁺², Fe⁺³ Cu⁺², Ag⁺¹, Mn⁺², Cr⁺³, CO⁺², Ni⁺², Al⁺³, Au⁺³, and Pt⁺² etc.). However, the hydrophobic properties of these dielectric sealing material systems are also strongly dependent upon the formation of covalent bond network with tetragonal structure as a stable material phase.

A first object of this invention is to provide a dielectric sealing material with high mechanical strength and high dielectric strength for solving industrial hermetic seal challenges. A second object of this invention is to provide a dielectric sealing material that has at least 5,000MΩ (at 500 VDC) resistance at 300° C. A third object is to provide a water-repelling dielectric sealing material that can be engineered by phase and morphology control to turn water-repelling properties from hydrophilic to moisture-resistant or hydrophobic properties. A fourth object is to provide a hydrophobic dielectric sealing material that can be used in harsh environments, such as a water/steam power generation turbomachinery system, petrochemical plant, subsea facility, and high radiative nuclear reactor in general, but more specific for an electrical feedthrough, integrated with downhole logging tools (LWD, MWD), to be reliably operated in water-based wellbores or moisture-rich oil-based wellbores for oil/gas exploration, completion, and production. In some embodiments, a dielectric sealing material may have a chemical composition that may include: H₃BO₃ 10-60 mol %; Bi₂O₃ 10-50 mol %; MO (such as TiO₂, BaO, ZnO, ZrO₂, SiO₂, SnO₂, Ga₂O₃, and/or Fe₂O₃) 10-50 mol %; SiO₂ 0-15 mol %; one or more rare earth oxides 0-5 mol % as additives (such as CeO₂, Y₂O₃, La₂O₃, Pr₆O₁₁, Nd₂O₃, Sm₂O₃, Eu₂O₃, Gd₂O₃, Tb₄O₇, Dy₂O₃, Ho₂O₃, Er₂O₃, Yb₂O₃, Lu₂O₃, Sc₂O₃, and Tm₂O₃). In further embodiments, the dielectric sealing material may not contain any Alkali metal ions and oxides (such as, Li+, Na+, K+, and P+, CaO, CaCO₃, Li₂O, Li₂O₂, LiO₂, Na₂O, Na₂O₂, NaO₂, K₂O, K₂O₂, and KO₂, etc.). In further embodiments, the dielectric sealing material may not contain any metal ions (such as Fe⁺², Fe⁺³ Cu⁺², Ag⁺¹, Mn⁺², Cr⁺³, CO⁺², Ni⁺², Al⁺³, Au⁺³, and Pt⁺² etc.).

In some embodiments, a method for making hydrophobic sealing material may include: selecting water insoluble raw materials; forming tetragonal dominated phase; and enlarging band-gap with wide-band-gap material. The morphology of the sealing material is preferably a tetrahedral phase dominated covalent bond network for obtaining high electrical insulation resistance, dielectric strength and hydrophobicity, and high mechanical strength in against downhole 30,000 PSI/300° C. water-based hostile environments.

### BRIEF DESCRIPTION OF THE DRAWINGS

Some embodiments of the present invention are illustrated as an example and are not limited by the figures of the accompanying drawings, in which like references may indicate similar elements and in which:

FIG. 1A—FIG. 1A depicts a diagram of an example of glass based dielectric sealing material having an amorphous phase and a random morphology according to various embodiments described herein.

FIG. 1B—FIG. 1B illustrates a diagram of an example of dielectric sealing material having a monoclinic phase with a trigonal structure according to various embodiments described herein.

FIG. 1C—FIG. 1C shows a diagram of an example of dielectric sealing material having a monoclinic and tetragonal mixed phase with a mixed trigonal structure according to various embodiments described herein.

FIG. 1D—FIG. 1D depicts a diagram of an example of dielectric sealing material having in which both Bi₂O₃ and B₂O₃ materials form a continuous covalent bond tetrahedral structure as a covalent bond tetrahedral network according to various embodiments described herein.

FIG. 2—FIG. 2 depicts a triangulation phase diagram for making exemplary dielectric sealing material with different phases and morphologies according to various embodiments described herein.

FIG. 3—FIG. 3 illustrates an example of glass transition temperature, glass softening point, and coefficient of thermal expansion determined by a dilatometer system from a specific hydrophobic dielectric sealing material system.

FIG. 4A—FIG. 4A illustrates a diagram of an example of how the carriers (electrons or holes) may transport from ground state (covalent band) either directly to conductive band or indirectly to conductive band from impurity levels in a dielectric sealing material according to various embodiments described herein.

FIG. 4B—FIG. 4B shows a diagram of an example of electronical band gap modification to enhance insulation resistance, dielectric strength, thermal stability, and thermal shock resistance via the incorporation of the wide-band-gap material into the dielectric sealing material according to various embodiments described herein.

FIG. 5—FIG. 5 depicts a graph comparing the electrical resistivity of a ternary-compositional system dielectric sealing material, a quaternary-compositional system dielectric sealing material, and a 99.6% purity Alumina material according to various embodiments described herein.

FIG. 6—FIG. 6 illustrates a graph depicting the insulation resistance measurements of a ternary-compositional system dielectric sealing material after exposure to four different conditions according to various embodiments described herein.

FIG. 7—FIG. 7 shows a graph comparing the hydrophobicity performance of a tetrahedral phase dominated dielectric sealing material and a trigonal phase dominated dielectric sealing material according to various embodiments described herein.

FIG. 8—FIG. 8 depicts a graph showing a pressure shock test on an electrical feedthrough prototype sealed with tetragonal quaternary sealing material, at ambient and 200° C. with pressure cycle from ambient 0 PSI to 30,000 PSI with 5-min duration at each status, or a 10-min per cycle according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

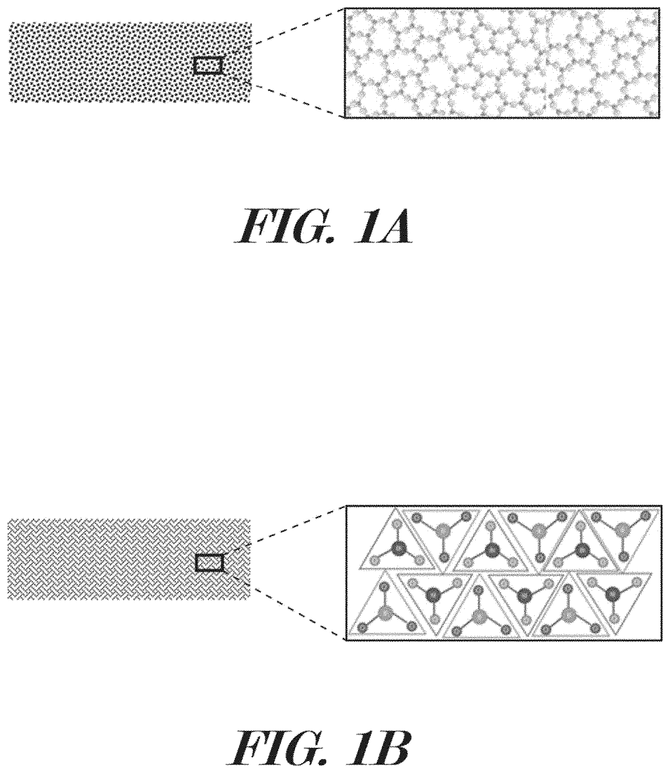

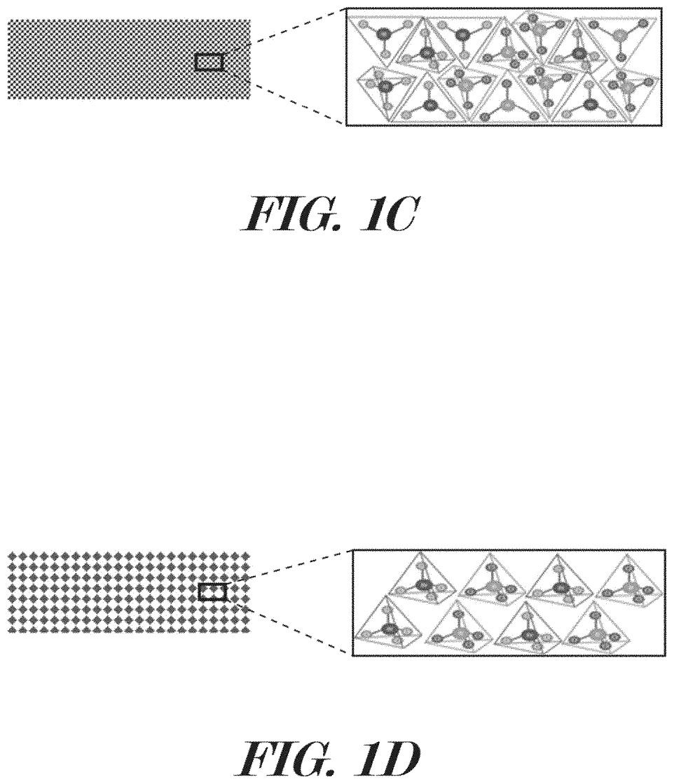

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Novel dielectric sealing materials are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

The present invention will now be described by example and through referencing the appended figures representing preferred and alternative embodiments.

According to the present disclosure a novel dielectric sealing material platform is provided. In some embodiments, the dielectric sealing material may be bismuth oxide based, and may comprise a chemical composition of x.H₃BO_{3-y}.Bi₂O₃-(1−x−y−z−δ).MO-z.SiO₂-δ.REO as a multi-composition material system, in which (1−x−y−z−δ), x, y, z, and δ represent the mole percentage of MO, H₃BO₃, Bi₂O₃, SiO₂, and REO, respectively. In some embodiments, MO may comprise TiO₂, BaO, ZnO, ZrO₂, SiO₂, SnO₂, Ga₂O₃, and/or Fe₂O₃ etc., and REO represents rare earth oxide oxides which may enhance dielectric sealing material moisture resistance and which may include lanthanum series based rare earth oxide oxides including CeO₂, Y₂O₃, La₂O₃, Pr₆O₁₁, Nd₂O₃, Sm₂O₃, Eu₂O₃, Gd₂O₃, Tb₄O₇, Dy₂O₃, Ho₂O₃, Er₂O₃, Yb₂O₃, Lu₂O₃, Sc₂O₃, and Tm₂O₃. In further embodiments, the dielectric sealing material can be synthesized as binary-compositional system of x.H₃BO₃-(1−x).Bi₂O₃, in which (1−x) and x represent the mole percentage of Bi₂O₃, and H₃BO₃, respectively and/or x.B₂O₃-(1−x).Bi₂O₃, in which (1−x) and x represent the mole percentage of Bi₂O₃, and B₂O₃, respectively. In still further embodiments, the dielectric sealing material can be synthesized as a ternary-compositional system of x.Bi₂O₃-(1−x−y).MO-y.H₃BO₃, in which (1−x−y), x, and y represent the mole percentage of MO, Bi₂O₃, and H₃BO₃, respectively and/or x.H₃BO₃-y.Bi₂O₃-(1−x−y). SiO₂, in which (1−x−y), x, and y represent the mole percentage of SiO₂, H₃BO, and Bi₂O₃, respectively. In still further embodiments, the dielectric sealing material can be synthesized as a quaternary-compositional system of x.H₃BO₃-y.Bi₂O₃-(1−x−y−z).MO-z.SiO₂, in which (1−x−y−z), x, y, and z represent the mole percentage of MO, H₃BO₃, Bi₂O₃, and SiO₂, respectively and/or x.H₃BO₃-y.Bi₂O₃-(1−x−y−δ).MO-δ.REO, in which (1−x−y−b), x, y, and δ represent the mole percentage of MO, H₃BO₃, Bi₂O₃, and REO, respectively. In still yet further embodiments, the dielectric sealing material can be synthesized as a quinary-compositional system of x.H₃BO₃-y.Bi₂O₃-(1−x−y−z−δ).MO-z.SiO₂-δ.REO, in which (1−x−y−z−δ), x, y, z, and δ represent the mole percentage of MO, H₃BO₃, Bi₂O₃, SiO₂, and REO, respectively. In even further embodiments, the dielectric sealing material can be synthesized as any combination of these binary, ternary, quaternary, and/or quinary material systems. The dielectric properties of this multi-compositional dielectric sealing material can be engineered for having water repelling properties varying from hydrophilic to moisture-resistant or hydrophobic, even to super-hydrophobic properties. Additionally, the described chemical compositions are critical for synthesizing moisture-resistant or hydrophobic dielectric sealing material that requires no alkali ions and alkaline metal oxides.

In further preferred embodiments, the dielectric sealing material may comprise a multi-compositional dielectric sealing material system having different chemical compositions and mole percentages and including: H₃BO₃ 10-60 mol %; Bi₂O₃ 10-50 mol %; MO (MO=TiO₂, BaO, ZnO, ZrO₂, SiO₂, SnO₂, Ga₂O₃, and/or Fe₂O₃) 10-50 mol %; SiO₂ 0-15 mol %; Rare earth oxide(s) (REO) 0-5 mol %; without any contamination by Alkali metal ions and oxides, and Fe⁺², Fe⁺³ Cu⁺², Ag⁺¹, Mn⁺², Cr⁺³, CO⁺², Ni⁺², Al⁺³, Au⁺³, and Pt⁺² etc. metal ions.

In some embodiments, a method for making hydrophobic sealing material may include: selecting water insoluble raw materials; forming tetragonal phase dominated phase; and enlarging band-gap with wide-band-gap material. The morphology of the sealing material is preferably a tetrahedral phase dominated covalent bond network for obtaining high electrical insulation resistance, dielectric strength and hydrophobicity, and high mechanical strength in against downhole 30,000 PSI/300° C. water-based hostile harsh environments.

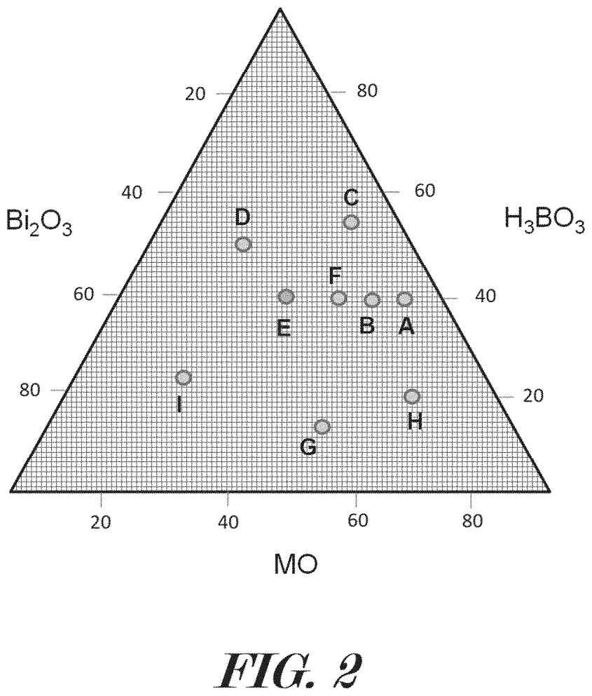

The triangulation diagram of FIG. 2 with primary Bi₂O₃, H₃BO₃, MO composition can be used to design a multi-compositional dielectric sealing material system with desirable phases and properties. A synthesized material may have nanocrystalline, microcrystalline, and polycrystalline, and amorphous microstructures. While each crystalline phase may include different morphologies such as monoclinic, trigonal, tetragonal, hexagonal, etc. In most cases, a synthesized material may be a mixture of poly-morphologies and/or phases. In still further preferred embodiments, the dielectric sealing material may comprise a monoclinic and tetrahedral mixed phase composed of the triangle and tetragonal mixed clusters. The down selection of the desired material compositions significantly determines the mechanical, thermal, and dielectric properties of the synthesized dielectric sealing material. This diagram enables different material selection for making a binary sealing material system (such as Bi₂O₃—H₃BO₃, and Bi₂O₃—B₂O₃), a ternary dielectric sealing material system (such as Bi₂O₃—H₃BO₃-MO and Bi₂O₃—H₃BO₃—SiO₂), a quaternary sealing material system (such as Bi₂O₃—H₃BO₃-MO-REO), and even quinary sealing material system (such as Bi₂O₃—H₃BO₃-MO-SiO₂—REO). The glass transition temperature (Tg) is more or less depending upon the ratio of the Bi₂O₃/H₃BO₃ and Bi₂O₃/MO, where high ratio of Bi₂O₃/H₃BO₃ and low ratio of Bi₂O₃/MO could reduce Tg. For most of practical electrical feedthrough package material and conductive pins, used for downhole less than 300° C. condition, the desirable Tg temperature may be in the range from 350° C. to 550° C. However, a selected material system may be more preferred to be of various phase microstructures with some specific morphologies.

When a dielectric sealing material is synthesized with different material phase structures and morphologies, which may dictate the water repelling properties of these dielectric sealing materials. In some embodiments, a dielectric sealing material may be synthesized with an amorphous glass phase and random morphology which may provide the dielectric sealing material with hydrophilic performance. In other embodiments, a dielectric sealing material may be synthesized with a monoclinic-tetragonal mixed phase and morphologies which may provide the dielectric sealing material with moisture-resistant performance. In further embodiments, a dielectric sealing material may be synthesized with a tetrahedral phase dominated morphologies and network which may provide the dielectric sealing material with hydrophobicity. In yet further embodiments, a dielectric sealing material may be synthesized with a continuous tetrahedral covalent-bond network which may provide the dielectric sealing material with super-hydrophobicity.

To make a hydrophobic dielectric sealing material that has high electrical insulation and dielectric strength, the dielectric sealing material preferably may comprise water insoluble network former(s) and network modifier(s) with varied compositions from each raw oxide material. For the disclosed dielectric sealing material, Bi₂O₃ is the starting material and one or more other materials may be combined with. First, Bi₂O₃ is water insoluble, and has been widely used in microelectronic package seals and products. Bi₂O₃ acts as both glass-network former with [BiO₃] pyramidal units and as modifier with [BiO₆] octahedral units.

However, Bi₂O₃ material has five polymorphic forms or morphologies with two stable polymorphs, namely monoclinic α phase and face-centered cubic δ phase, and with three metastable phases, namely, tetrahedral β phase, body-centered-cubic γ phase, and triclinic ω phase. The dielectric sealing material has to be one of stable polymorphs, either the monoclinic α phase or δ phases. Unfortunately, both phases may be not of hydrophobic properties. The sealing material may be of superior water repelling capability if the Bi₂O₃ is with tetrahedral β phase.

During glass firing process the initial sintered glass frit was fired at a certain temperature that the glass structure may transform to the cubic δ-Bi₂O₃ if it is heated above 730° C., until melting at 820-860° C. The microstructure of Bi₂O₃ during cooling process will be transformed from the δ-phase to tetragonal β-phase or γ-phase, then to α-phase (Eg≈2.7 eV) or with multi-phase microstructures, depending upon the cooling process. On the other hand, on cooling δ-Bi₂O₃ process it is possible to form two intermediate metastable phases at ambient conditions: the tetragonal β phase (Eg≈2.5 eV) at ˜650° C., and the body-centered cubic γ phase at ˜640° C. The γ-phase can exist at room temperature with very slow cooling rates, but α-phase Bi₂O₃ always forms on cooling the β-phase. The α-phase exhibits p-type electronic conductivity at room temperature which transforms to n-type conductivity (charge is carried by electrons) between 550° C. and 650° C., depending on the oxygen partial pressure. Though α-Bi₂O₃ is more easily obtained, β-Bi₂O₃ can be obtained despite of the difficulty in synthesizing this metastable phase.

For obtaining a desirable and reliable dielectric sealing material with high dielectric strength, it is critical that the final material has a β-phase structure. Optionally, one or more additional oxides may be added to form a Bi₂O₃ based dielectric sealing material with stable tetragonal β-phase. In preferred embodiments, the first added-in oxide may be boric acid (H₃BO₃), which is used as fluxing agent for glass and enamels, and its thermal decomposition process occurs at a temperature near 235° C. by

2H₃BO₃→B₂O₃+3H₂O (1)

where B₂O₃ glass contains BO₃ triangular units or BO₄ tetrahedral, depending on pressure. The Boron trioxide is normally vitreous form but can be crystallized after extensive annealing or compressive pressure to have different phase. It has shown that pressure, together with temperature, is a key external variable which determines the structure and properties of solids. For example, the tetrahedral structure may become the dominated microstructure in a B₂O₃ material with >10 GPa compression.

In further embodiments, the dielectric sealing material may comprise a second added-in oxide of MO, where MO may be TiO₂, BaO, ZnO, ZrO₂, SiO₂, SnO₂, Ga₂O₃, and/or Fe₂O₃. This second oxide can act as network modifier, for example, to form Bi—O₃-M-BO₃ network, or as material dielectric modifier to modify electron energy band gap. For example, the oxide BaO may enhance the dielectric properties of the dielectric sealing material by leveraging its wide band gap of 4.0-4.8 eV that also enables the dielectric sealing material to be thermally stable at elevated temperature. Both Bi₂O₃ and B₂O₃ materials may have their trigonal structures as stable status, but the incorporation of the MO (TiO₂, BaO, ZnO, ZrO₂, SiO₂, SnO₂, Ga₂O₃, and/or Fe₂O₃ etc.) may be used to provide better connection from different trigonal structures between Bi₂O₃ and B₂O₃ by matching bond coordination number, bond length and bond angle.

In further embodiments, the dielectric sealing material may include a third added-in oxide that may comprise wide band-gap material, such as silicon dioxide (SiO₂) material, which is also used as network modifier to modify thermal resistance capability, material hardness, and mechanical and flexural strength. In preferred embodiments, the dielectric sealing material may comprise one or more wide-band-gap based oxide materials to improve molecule connectivity and uniform network formation in the synthesized sealing material. SiO₂ may have either nanocrystalline quartz structure or amorphous random glass phase with band gap from 8.6 eV to 9.0 eV. By incorporating a wide band gap material, such as SiO₂, BaO, MgO, ZrO₂, Al₂O₃, Ga₂O₃, SnO₂, etc., into the dielectric sealing material, the wide band gap material may effectively improve thermal shock resistance, maximum allowable operating temperature, and insulation resistance by enlarging dielectric sealing material band-gap structures. In preferred embodiments, a wide band gap oxide material may have an energy band gap that is at or between approximately 3.5 eV and 9.0 eV. In addition, lanthanum series based rare earth oxide oxides (REO) may be used as additives in the dielectric sealing material for potentially improving dielectric sealing material surface water repelling properties with low surface fee energy and non-polar surface structure. Additionally, a REO additive may repel conductive scaling onto the dielectric sealing material surface.

Thus, in some embodiments, the dielectric sealing material of the present disclosure may be a binary glass system (for example, Bi₂O₃—H₃BO₃ or Bi₂O₃—B₂O₃), a ternary system (for example, Bi₂O₃—H₃BO₃-MO), a quaternary system (for example, Bi₂O₃—H₃BO₃-MO-SiO₂), and a quinary system (for example, Bi₂O₃—H₃BO₃-MO-SiO₂-REO). In some embodiments, the dielectric sealing material may comprise a binary-compositional system of x.H₃BO₃-(1−x).Bi₂O₃. In further embodiments, the dielectric sealing material may comprise a ternary-compositional system of x.Bi₂O₃-(1−x−y).MO-y.SiO₂. In still further embodiments, the dielectric sealing material may comprise a ternary-compositional system of x.H₃BO₃-y.Bi₂O₃-(1−x−y).MO. In further embodiments, the dielectric sealing material may comprise a quaternary-compositional system of x.H₃BO₃-y.Bi₂O₃-(1−x−y−z).MO-z.SiO₂. In yet further embodiments, the dielectric sealing material may comprise a quaternary-compositional system of x.H₃BO₃-y.Bi₂O₃-(1−x−y−δ).MO-δ.REO. In still yet further embodiments, the dielectric sealing material may comprise a quinary-compositional system of x.H₃BO₃-y.Bi₂O₃-(1−x−y−z−δ).MO-z.SiO₂-δ.REO.

In alternative embodiments, the dielectric sealing material of the present disclosure may comprise a dielectric sealing material comprising Bi₂O₃ and one or more other oxides in which the Bi₂O₃ and one or more other oxides are arranged in trigonal and tetragonal structures and morphologies. In some embodiments, the dielectric sealing material may comprise x.H₃BO₃-(1−x).Bi₂O₃. In further embodiments, the dielectric sealing material may comprise x.Bi₂O₃-(1−x−y).MO-y.SiO₂. In still further embodiments, the dielectric sealing material may comprise x.H₃BO₃-y.Bi₂O₃-(1−x−y).MO. In further embodiments, the dielectric sealing material may comprise x.Bi₂O₃-(1−x−y).MO-y.SiO₂ and x.H₃BO₃-y.Bi₂O₃-(1−x−y).MO. In yet further embodiments, the dielectric sealing material may comprise x.H₃BO₃-y.Bi₂O₃-(1−x−y−z).MO-z.SiO₂. In yet further embodiments, the dielectric sealing material may comprise x.H₃BO₃-y.Bi₂O₃-(1−x−y−δ).MO-δ.REO. In still yet further embodiments, the dielectric sealing material may comprise x.H₃BO₃-y.Bi₂O₃-(1−x−y−z−δ).MO-z.SiO₂-δ.REO.

The down selection of an additive to the dielectric sealing material may be dependent upon the needs in hermetic package sealing and its application. In one case, a dielectric sealing material may be required to have moisture-resistant properties and low-temperature softening point of less than 600° C. In another case, the dielectric sealing material may be required to have high water repelling properties and high mechanical bonding strength to reliably sustain in the harsh environment, such as in steam turbine. In further case, the dielectric sealing material may be required to have high electrical insulation resistance, high dielectric strength, high mechanical bonding strength, and hydrophobicity to reliably sustain in the harsh environment, such as steam turbine, downhole, nuclear reactor etc. In fact, a downhole electrical feedthrough package may require a dielectric sealing material to have not only high electrical insulation resistance, high dielectric strength, high mechanical bonding strength, and hydrophobicity, but also high thermal and pressure shock resistance.

To make a dielectric sealing material that may be particularly suited for satisfying downhole logging tool needs as above addressed, the dielectric sealing material should have a desirable phase and morphology after synthesis and post process. A dielectric sealing material with an amorphous phase or mixed with monoclinic phase is more likely of hydrophilic properties, similar to most of ceramic materials. The hydrophilicity of such dielectric sealing materials may dictate that these dielectric sealing materials may be used in no water/steam environments because of intrinsic porosity. A dielectric sealing material with dominated monoclinic α-phase may have hydrophilic to moisture-resistant properties with certain mole percentages or ratios among Bi₂O₃, H₃BO₃, and MO compositions and morphology formation. The mixing phase of monoclinic and tetragonal structures can be obtained and the hydrophobicity is more dependent upon the relative ratio between monoclinic and tetragonal structures and can be tailored by the control of the processing temperature. For relative low ratio, the dielectric sealing material may show weak hydrophobicity. In preferred embodiments, a dielectric sealing material may have a continuous tetragonal structure, namely, forming sp3 molecular morphology dominated covalent bond network, where the molecular bond angle(s) is close to 109.5°. In such a tetrahedral molecular geometry, central atoms such as Bi or B, even Bi—B, B—Si, or/and Bi—Si, are located at the center with four substituents that are located at the corners of a tetrahedron.

FIG. 2 depicts a triangulation phase diagram for making exemplary dielectric sealing material with different phases and morphologies according to various embodiments described herein. Table 1 illustrates nine synthesized dielectric sealing materials (A, B, C, D, E, F, G, H and I) that are composed of the 10-50 mol % MO, 10-60 mol % H₃BO₃, 10-50 mol % Bi₂O₃, 0-15 mol % SiO₂, and 0-5 mol % Rare earth oxide (REO). These dielectric sealing materials may be synthesized by conventional melt-quench technique using reagent grade chemicals and, following a high compression process (>10 GPa) to prompt the formation of the tetragonal β-phase.

TABLE 1

| | Bi₂O₃ | H₃BO₃ | MO | SiO₂ | REO |
|---|---|---|---|---|---|
| Sample | (mol %) | (mol %) | (mol %) | (mol %) | (mol %) |
| A | 39 | 49 | 10 | 2 | 0 |
| B | 40 | 45 | 12 | 2 | 1 |
| C | 47 | 30 | 9 | 2 | 2 |
| D | 40 | 16 | 24 | 15 | 5 |
| E | 40 | 30 | 30 | 0 | 0 |
| F | 40 | 40 | 20 | 0 | 0 |
| G | 13 | 57 | 30 | 0 | 0 |
| H | 19 | 57 | 19 | 3 | 2 |
| I | 20 | 20 | 50 | 8 | 2 |

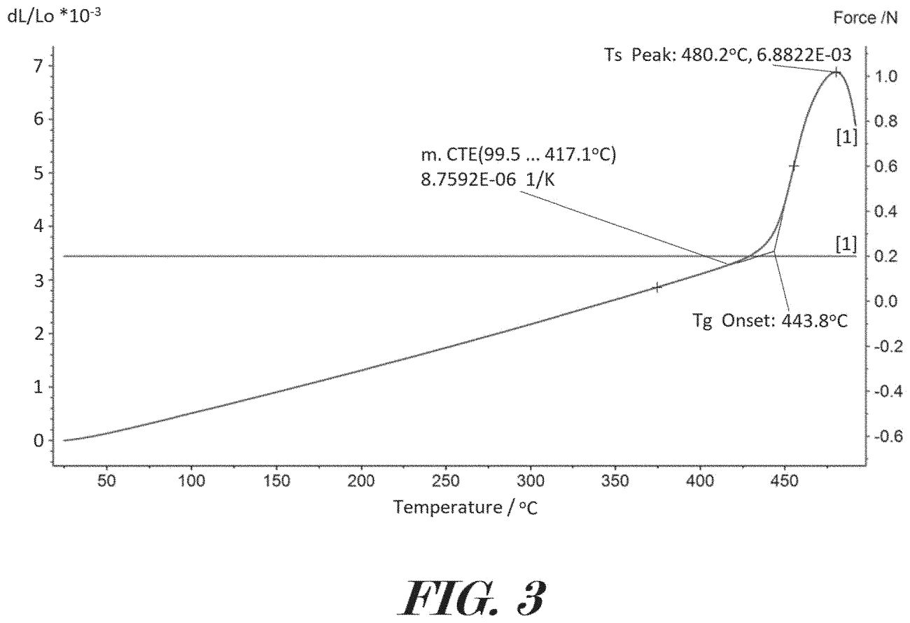

As shown in Table 1, SiO₂ material may be used as an additive if MO is not SiO₂, however, REO is more preferred as additional additive to optimize the dielectric material moisture-resistant properties and specifically to repel potential scaling or dirt that is frequently seen from harsh environment. As specific example, FIG. 3 has shown a dilatometer measured the glass transition temperature (Tg=443.8° C.) and averaged coefficient of thermal expansion (CTE=8.76×10⁶ m/m·° C.) from sample G in Table 1, in addition, its density is about 5.53 g/cm³ and the glass soft point is around 480.2° C. In fact, as increasing the Bi₂O₃ mole percentage from 10% to 47%, the glass transition temperature can gradually decrease from 550° C. to about 350° C., accompanying the increase of the density from 4.5 g/cm³ to 7.6 g/cm³

Controlling the percentage of primary Bi₂O₃, H₃BO₃, MO, can be used to synthesize a dielectric sealing material with desired performance in both mechanical and dielectric properties. One or more oxides may be down selected to form a dielectric sealing material which may be a binary glass system (for example, Bi₂O₃—H₃BO₃ or Bi₂O₃—B₂O₃), a ternary system (for example, Bi₂O₃—H₃BO₃-MO), quaternary system (for example, Bi₂O₃—H₃BO₃-MO-SiO₂) and a quinary system (for example, Bi₂O₃—H₃BO₃-MO-SiO₂—REO). As an example, the quaternary H₃BO₃—Bi₂O₃-MO-SiO₂ based dielectric sealing materials have shown glass transition temperature from 350° C. to 550° C., but decreasing glass transition temperature with the increasing of Bi₂O₃/B₂O₃ ratio, and increasing glass transition temperature with the increasing of MO/B₂O₃ ratio. The coefficient of thermal expansion could be varied from 6.0×10⁻⁶ m/m·° C. to 12.5×10⁻⁶ m/m·° C., with values increasing with Bi₂O₃/B₂O₃ ratio, MO/B₂O₃ ratio, and SiO₂ dopants. In preferred embodiments, the dielectric sealing material may have a transition temperature from approximately 350° C. to 550° C., a thermal expansion coefficient between approximately 6.0×10⁻⁶ m/m·° C. to 12.5×10⁻⁶ m/m·° C., a mass density between approximately 4.5 g/cm³ and 7.6 g/cm³, and a Young's modulus of between approximately 65 GPa and 80 GPa.

The synthesized dielectric sealing material may have different phase structures that may dictate its water repelling capabilities as illustrated by FIGS. 1A-1D. However, there is no well-known method in the prior art for controlling material's morphology for making bismuth oxide based dielectric sealing material. Furthermore, there is no well-known method in the prior art for synthesizing bismuth oxide based material with preferred morphology or phase as moisture-resistant or hydrophobic material either. First synthesized phase and morphology is short-range and atoms random connected amorphous glass phase and microstructures, FIG. 1A, has a random morphology that is more likely of hydrophilic properties because of the broken bonds at surface for —OH hydroxyl ions diffusion, which is controlled by fast quenching process of the sintered and fired synthesized material when the synthesizing process is conducted under certain temperature and pressure conditions, the monoclinic α-phase may become dominate the dielectric sealing material morphology, which is controlled by relative slow quenching process on the sintered and fired synthesized material. Most likely, trigonal structure may form network bulk material, as shown in FIG. 1B. Normally, the dielectric sealing material may also contain tetragonal phase, mixed with trigonal structure as shown in FIG. 1C. In another case, all the trigonal structures from both Bi₂O₃ and B₂O₃ materials may form a continuous covalent bond tetrahedral structure, as shown in FIG. 1D, which is controlled by slow quenching process on the sintered material and isothermal process on the fired material.

In some preferred embodiments, the dielectric sealing material may have amorphous glass phase and random morphology (FIG. 1A), thereby granting the dielectric sealing material to be more likely to be hydrophilic in performance. In further preferred embodiments, the dielectric sealing material may have a monoclinic and tetragonal mixed phase (FIG. 1C), thereby granting the dielectric sealing material to be more likely to be moisture-resistant in performance. In some embodiments, the monoclinic phase may consist of triangle clusters and microstructures. In further embodiments, the monoclinic and tetrahedral mixed phase may be composed of the triangle and tetragonal cluster mixed phases. In preferred embodiments, an amorphous and monoclinic phase dielectric sealing material may have approximately between 1.0×10¹¹ to 1.0×10¹³ Ω-cm volumetric resistivity. In still further preferred embodiments, the dielectric sealing material may have a monoclinic and tetragonal mixed phase but with the tetrahedral phase dominated microstructures, and the dielectric sealing material may have greater than 1.0×10¹² Ω-cm volumetric resistivity at 177° C. In yet further preferred embodiments, the dielectric sealing material may be tetrahedral phase dominated and may have ternary and quaternary multi-compositional material combinations to enable high mechanical and electrical strengths in synthesized dielectric sealing material.

In yet further preferred embodiments, the dielectric sealing material may have a tetrahedral covalent-bond network (FIG. 1D), thereby granting the dielectric sealing material to be more likely to be super-hydrophobic in performance for long-term sustaining in the moisture-rich or water/steam environment without losing insulation resistance. In some preferred embodiments, the tetrahedral covalent-bond network may be primarily composed of tetrahedral clusters and microstructures with sp3 molecular structure, where each Bi, B, Si, Bi—B, B—Si, Bi—Si atoms are surrounded by 4 oxygen atoms. In further preferred embodiments, the dielectric sealing material may have a tetrahedral covalent-bond network that may be composed of microstructural tetrahedral clusters with a typical size approximately between 0.1 micrometer to three micrometers. In still further embodiments, the dielectric sealing material may be tetrahedral phase dominated and may have a volumetric resistivity amplitude of 1.0×10¹⁸ to 1.0×10¹⁹ Ω-cm at 0° C. and have greater than 5.0×10¹⁰ Ω-cm volumetric resistivity or 5,000 MΩ insulation resistance at 300° C. temperature.

In some embodiments, a dielectric sealing material may include, such as by being doped with, a wide-band-gap material, such as SiO₂, ZnO, MgO, ZrO₂, SnO₂, Ga₂O₃, Al₂O₃ etc., that may be incorporated with the silicon dioxide and may be critical to the dielectric sealing material to ensure high electrical insulation resistance, dielectric strength, maximum operating temperature, and thermal shock resistance that are needed for making a downhole electrical feedthrough package. In some preferred embodiments, a dielectric sealing material may include, such as by being doped with, a wide-band-gap material such as SiO₂ (˜9.0 eV), ZnO (3.5 eV), BaO (4.0-4.8 eV), SnO₂ (3.57 eV-3.93 eV), Ga₂O₃ (4.5 eV), MgO (7.8 eV), ZrO₂ (˜6.0 eV), and Al₂O₃ (7.6 eV) etc. to enhance the dielectric sealing material's thermal stability and toughness in against harsh environmental conditions.

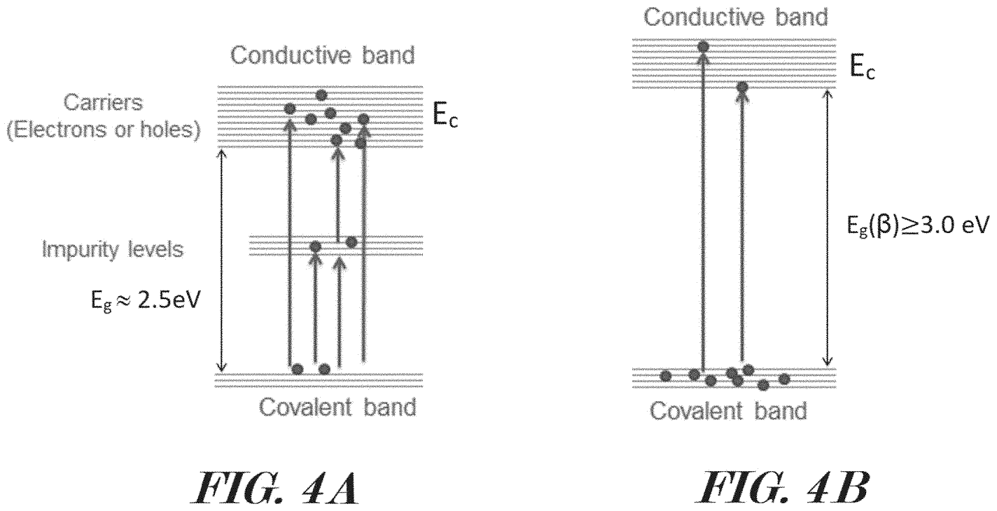

FIGS. 4A and 4B illustrate an example of a material band-gap modification process that could remove impurity levels for high thermal stability and enlarge band-gap for increasing maximum allowable operating temperature by limiting carriers transport from covalent band to conductive band. FIG. 4A illustrates the carriers (electrons or holes) may transport from ground state (covalent band) either directly to conductive band or indirectly to conductive band from impurity levels. Of course, such a carrier transport is primary mechanism for a dielectric sealing material failure by loss of the electrical insulation resistance at elevated temperature. FIG. 4B further illustrates that the incorporation of the wide-band-gap material, such as SiO₂ (˜9.0 eV) and ZnO (˜3.5 eV), may enlarge band gap from original 2.5 eV of the Bi₂O₃ or α-phase to greater than 3.0 eV tetragonal structure.

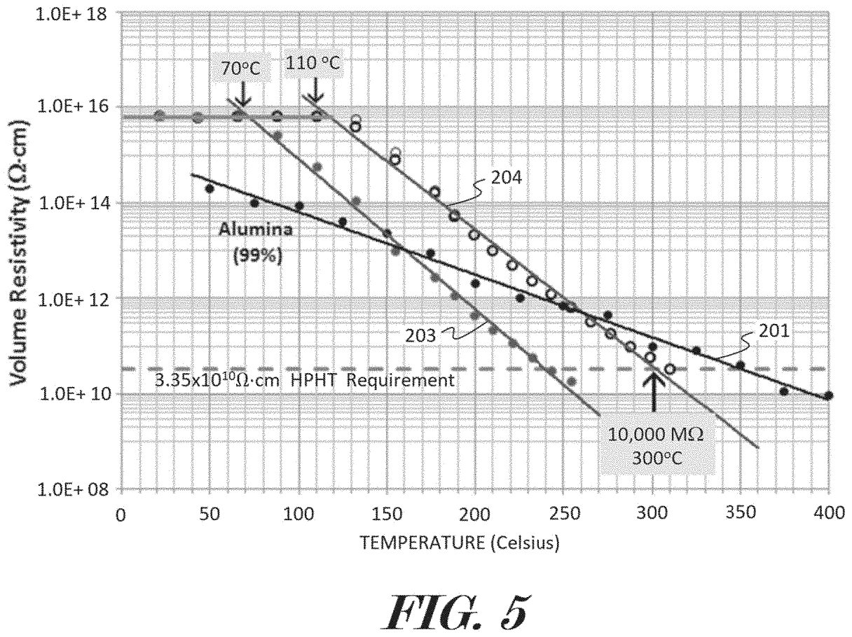

FIG. 5 illustrates how such a band-gap modification effectively enhanced electrical resistivity by SiO₂ doping into a ternary Bi₂O₃—H₃BO₃-MO material system. It shows that both Bi₂O₃—H₃BO₃-MO and Bi₂O₃—H₃BO₃-MO-SiO₂ dielectric sealing materials have about 0.65×10¹⁶ Ω-cm volumetric resistivity at ambient while Alumina or Al₂O₃ has about 1.0×10¹⁴ Ω-cm resistivity at ambient, which is about 50 times different. Furthermore, the resistivity of the Alumina material seems to be a linear function of the temperature that can be described by

ρ(T)=ρ(0)·exp(−χT)=1.31×10¹⁵·exp(−0.0302·T) (Ω-cm); for 99.6% purity Al₂O₃ (2)

However, the volumetric resistivity of the tetragonal Bi₂O₃—H₃BO₃-MO and Bi₂O₃—H₃BO₃-MO-SiO₂ dielectric sealing materials has no temperature dependence for T<70° C. and T<110° C., respectively. At higher temperature the resistivity of the dielectric sealing materials can be described by:

ρ(T)=1.15×10¹⁸·exp(−0.0725·(T−70)) (Ω-cm); for tetragonal Bi₂O₃—H₃BO₃-MO and T>70° C. (3)

ρ(T)=1.46×10¹⁹·exp(−0.0659·(T−110)) (Ω-cm); for tetragonal Bi₂O₃—H₃BO₃-MO-SiO₂ and T>110° C. (4)

By comparing the volumetric resistivity amplitude ρ(0), 1.31×10¹⁵, of the Alumina material, the resistivity amplitudes (1.15×10¹⁸ and 1.46×10¹⁹) of the dielectric sealing material of the present invention appears to be 3-4 orders higher at zero degrees Celsius because of the wide band-gap SiO₂ material modification. It is worth pointing out that the volumetric resistivity of the tetragonal quaternary dielectric sealing material, Bi₂O₃—H₃BO₃-MO-SiO₂, has a higher resistivity than the Alumina material at least up to 260° C. Moreover, by comparing the downhole electrical required resistance of 5,000MΩ or 3.35×10¹⁰ Ωcm volumetric resistivity, the tetragonal quaternary dielectric sealing material of the present invention could be allowed operating at least 300° C.; and its hydrophobic properties could further enable the sealed electrical feedthrough package reliably operating regardless if the oil/gas wellbore is filled with water or water-mud or oil, oil-mud, or their combination.

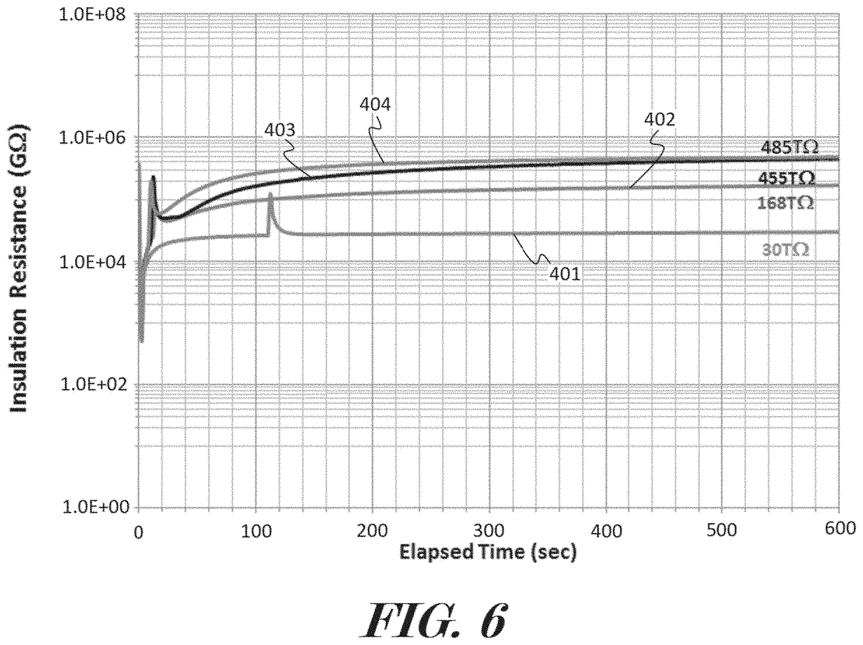

FIG. 6 shows the insulation resistance measurements of a weak hydrophobic or moisture-resistant example ternary Bi₂O₃—H₃BO₃-MO dielectric sealing material just after fabrication (labeled 401), after one hour soaking in 100° C. boiling water (labeled 402), after 2 hours test at 200° C. and 25,000 PSI water fluid (labeled 403), and after 140 hours 200° C. and 18,000-28.500 PSI water fluid (labeled 404). As seen from FIG. 6, the initial insulation resistance is only about 30 TΩ at 500 VDC, but this resistance increases to 168 TΩ at 500 VDC after one hour soaking in 100° C. boiling water. It is interesting to find that this resistance still increases to 455TΩ after 2 hours test at 200° C. and 25,000 PSI water fluid, and even reach to near 485 TΩ at 500 VDC after 140 hours 200° C. and 18,000-28.500 PSI water fluid test. The insulation resistance of this ternary Bi₂O₃—H₃BO₃-MO dielectric sealing material seems to have virtually no sensitivity to the high pressure and high temperature water/steam conditions. However, the increase of the insulation resistance under elevated temperature and pressure is related to the increased ratio of the tetragonal phase over trigonal phase. It should be pointed out that a dielectric sealing material has to have a volumetric resistivity of >3.35×10¹⁰ Ω-cm for downhole electrical feedthrough package, or insulation resistance of 5,000MΩ at 500 VDC, which has clearly identified the maximum allowable operating temperature of an electrical feedthrough sealed with this ternary Bi₂O₃—H₃BO₃-MO dielectric sealing material to be ˜243° C. Moreover, the volumetric resistivity of this ternary Bi₂O₃—H₃BO₃-MO based dielectric sealing material is greater than 1.0×10¹² Ω-cm at 177° C. downhole temperature and also has better resistivity than Alumina material (labeled by “201” in FIG. 5) at least up to 160° C. Such a ternary Bi₂O₃—H₃BO₃-MO dielectric sealing material, as labeled by “203” in FIG. 5, has demonstrated its high electrical insulation resistance, high mechanical strength, and high moisture-resistance properties.

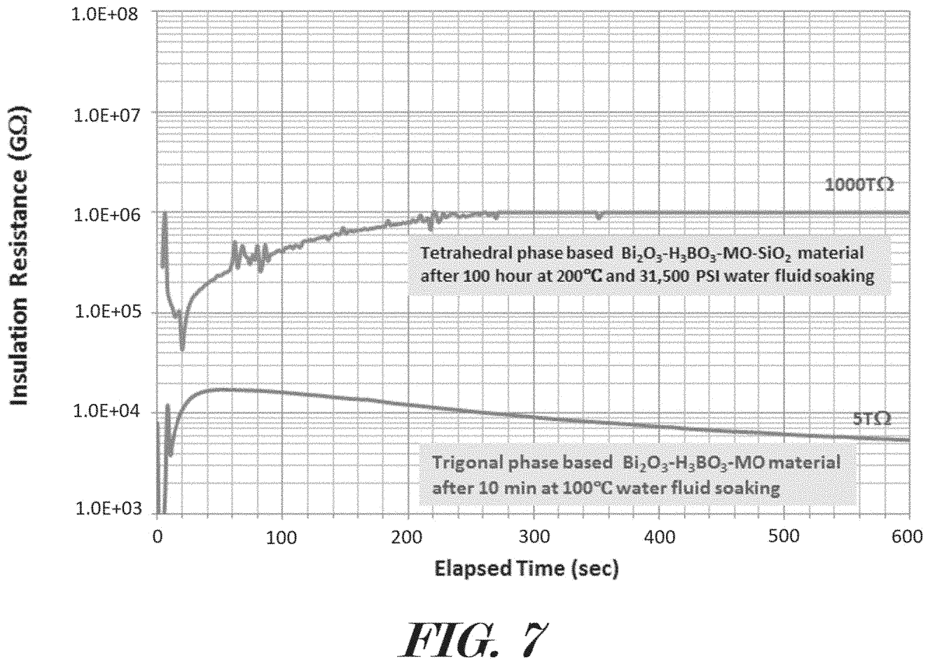

FIG. 7 illustrates that the band-gap-modification by SiO₂ material could greatly improve electrical insulation resistance even after 100 hours at 200° C. and 31,500 PSI water fluid test. By comparing with tetragonal ternary system, the insulation resistivity of the tetragonal quaternary system Bi₂O₃—H₃BO₃-MO-SiO₂ seems to show two times better performance than tetragonal ternary Bi₂O₃—H₃BO₃-MO system after water-based high-pressure and high-temperature tests. In addition, a trigonal phase based dielectric sealing material may not have desirable water repelling properties regardless of the ternary or quaternary material systems. One typical ternary material system (G in Table 1), Bi₂O₃—H₃BO₃-MO, with 13 mol. % for Bi₂O₃, 30 mol. % for MO=ZnO, and 57 mol. % for H₃BO₃, may lose insulation resistance even after 10-min 100° C. boiling water soaking because of the non-desirable phase structure. On the other hand, both FIGS. 6 and 7 have clearly verified that tetrahedral structures based covalent bond network can provide high moisture-resistance or water repelling capability, in other words, these newly developed dielectric sealing materials have desirable hydrophobicity that may become candidates for being used in downhole electrical feedthrough packages.

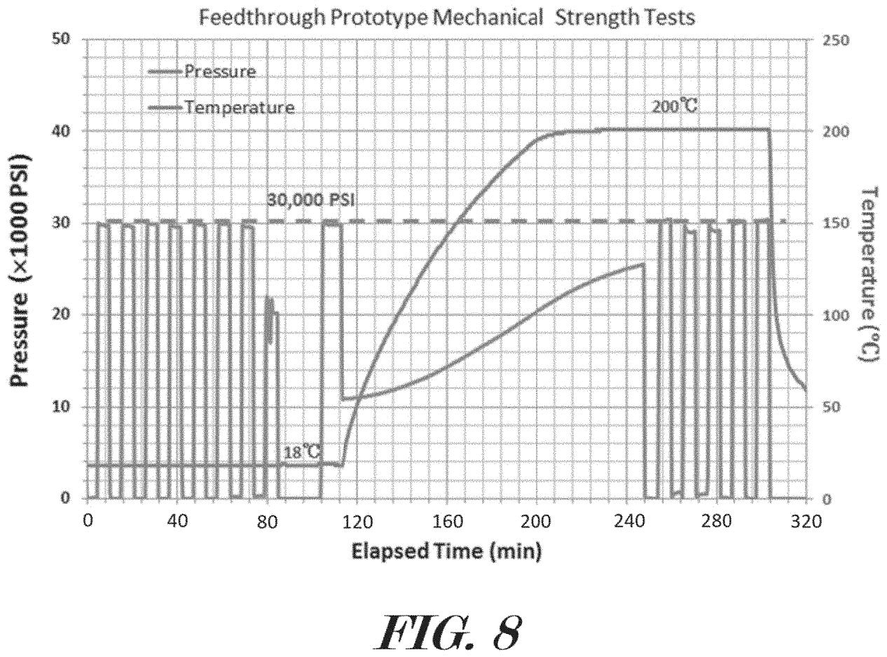

Downhole electrical feedthrough prototypes, sealed with tetragonal quaternary Bi₂O₃—H₃BO₃-MO-SiO₂ dielectric sealing material have been further tested for bonding performance with metal housing. It is a known occurrence that the field deployment of an electrical feedthrough with logging tool may suddenly suffer from a pressure shock due to downhole fluid leak event or mechanical shock by accidents. All these potential events may degrade and even break down downhole electrical feedthrough package sealing properties. FIG. 8 depicts a pressure shock test from an electrical feedthrough prototype, sealed with tetragonal quaternary dielectric sealing material, at ambient and 200° C. with pressure cycle from ambient 0 PSI to 30,000 PSI with 5-min duration at each status, or a 10-min per cycle. The first eight pressure cycles were done just at ambient (18° C.) by turning hydraulic pressure from zero to approximately 30,000 PSI, and maintaining this pressure level for about five minutes, then, discharging the water fluid from the testing chamber, where the electrical feedthrough prototype is installed inside with an O-ring seal from one-side the package. After these ambient pressure shock cycles, the high pressure and high temperature (HPHT) testing system temperature was ramped to 200° C. After the testing chamber's temperature reaches 200° C., an additional 5 cycles are conducted with 10-min per cycle. After these pressure shock tests are completed, the prototype has still shown a hermeticity of 1.0×10⁻⁹ cc/sec He.

These tests on mechanical and electrical properties have further demonstrated that a tetragonal dielectric sealing material sealed electrical feedthrough package may be allowed to operate in up to 300° C. and 30,000 PSI harsh conditions. Additionally, the hydrophobic properties of the dielectric sealing material could further enable the sealed electrical feedthrough package reliably operate regardless the oil/gas wellbore filled with water or water-mud or oil, or their combination. By referencing requirements of minimum resistivity of 3.35×10¹⁰ Ω-cm or insulation resistance of 5,000MΩ for downhole electrical logging tools, it can be clearly observed that the maximum allowable operating temperature of an electrical feedthrough sealed with this tetragonal Bi₂O₃—H₃BO₃-MO-SiO₂ dielectric sealing material to be about 300° C., as seen from FIG. 5. Moreover, the resistivity of this quaternary Bi₂O₃—H₃BO₃-MO-SiO₂ based dielectric sealing material is greater than 1.0×10¹⁴ Ω-cm at 177° C. downhole temperature and also has better resistivity than 99.6% purity Alumina material up to 260° C. Such a hydrophobic dielectric sealing material, as labeled by “204” in FIG. 5, has demonstrated its superior electrical insulation resistance to Alumina ceramic material, in addition to its extra high mechanical strength and extra high moisture-resistance properties.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A hydrophobic dielectric sealing material, the dielectric sealing material having a chemical composition comprising:
H₃BO₃ 10-60 mol %;
Bi₂O₃ 10-50 mol %;
MO 10-50 mol %;
SiO₂ 0-15 mol %; and
a rare earth oxide 0-5 mol %.

2. The dielectric sealing material of claim 1, wherein the dielectric sealing material is a ternary-compositional system of x.Bi₂O₃-(1−x−y).MO-y.SiO₂ and x H₃BO₃-y.Bi₂O₃-(1−x−y).MO.

3. The dielectric sealing material of claim 1, wherein the dielectric sealing material is a quaternary-compositional system of x.H₃BO₃-y.Bi₂O₃-(1−x−y−z).MO-z.SiO₂.

4. The dielectric sealing material of claim 1, wherein the dielectric sealing material is a quinary-compositional system of x.H₃BO₃-y.Bi₂O₃-(1−x−y−z−δ).MO-z.SiO₂—δ.REO.

5. The dielectric sealing material of claim 1, wherein the dielectric sealing material has a glass transition temperature between 350° C. to 550° C., a thermal expansion coefficient between 6.0×10⁻⁶ m/m·° C. to 12.5×10⁻⁶ m/m·° C., a mass density between 4.5 g/cm³ and 7.6 g/cm³, and a Young's modulus between 65 GPa and 80 GPa.

6. The dielectric sealing material of claim 1, wherein the dielectric sealing material comprises a wide band gap based oxide material selected from the group consisting of TiO₂, BaO, ZnO, ZrO₂, SiO₂, SnO₂, Ga₂O₃, and Fe₂O₃.

7. The dielectric sealing material of claim 6, wherein the wide band gap oxide has an energy band gap that is between 3.5 eV and 9.0 eV.

8. The dielectric sealing material of claim 1, wherein the dielectric sealing material comprises monoclinic and tetragonal mixed phase morphology.

9. The dielectric sealing material of claim 8, wherein the monoclinic phase consists of triangle clusters.

10. The dielectric sealing material of claim 8, wherein the tetragonal phase consists of tetrahedral clusters.

11. The dielectric sealing material of claim 8, wherein the monoclinic and tetrahedral mixed phase are composed of the triangle and tetragonal mixed clusters.

12. The dielectric sealing material of claim 8, having a resistivity that is greater than 1.0×10¹² Ω-cm at 177° C.

13. The dielectric sealing material of claim 1, wherein the dielectric sealing material comprises a tetrahedral phase dominated microstructure.

14. The dielectric sealing material of claim 13, having a resistivity amplitude of 1.0×10¹⁸-1.0×10¹⁹ Ω-cm at 0° C., and having greater than 5.0×10¹⁰ Ω-cm resistivity at 300° C.

15. The dielectric sealing material of claim 10, having ternary and quaternary multi-compositional material combinations.

16. The dielectric sealing material of claim 1, wherein the dielectric sealing material comprises a tetrahedral covalent-bond network.

17. The dielectric sealing material of claim 16, wherein the dielectric sealing material is doped with wide-band-gap material.

18. The dielectric sealing material of claim 16, wherein the dielectric sealing material is composed of microstructural tetrahedral clusters with typical size between 0.1 and three micrometers.

19. The dielectric sealing material of claim 16, wherein the tetrahedral covalent-bond network may be primarily composed of tetrahedral phase and microstructures.

20. A hydrophobic dielectric sealing material system comprising a binary-compositional system having at least one of x.H₃BO₃-(1−x).Bi₂O₃ and x.B₂O₃-(1−x).Bi₂O₃.
